(19) United States
(12) Patent Application Publication
(10) Pub. No.: US 2024/0421737 A1
(43) Pub. Date: Dec. 19, 2024

(54) CEASING TRANSISTOR TOGGLING IN PERMANENT MAGNET MOTOR WHEN ZERO MOTOR TORQUE IS DEMANDED

(71) Applicant: Atieva, Inc., Newark, CA (US)

(72) Inventors: Ruxiao An, Sunnyvale, CA (US); Emad Dlala, Pleasanton, CA (US)

(21) Appl. No.: 18/701,480

(22) PCT Filed: Oct. 18, 2022
(86) PCT No.: PCT/US2022/078279

§ 371 Date: Apr. 15, 2024

Related U.S. Application Data
(60) Provisional application No. 63/262,911, filed on Oct. 22, 2021.

(51) Int. Cl. H02P 23/00; B60L 15/00; B60L 15/04; B60L 15/20; B60L 50/60; H02P 27/06

(52) U.S. Cl. CPC H02P 23/00; B60L 15/007; B60L 15/04; B60L 15/20; B60L 50/60; H02P 27/06; B60L 2240/421; B60L 2240/423

(57) ABSTRACT

A method comprises: receiving, by a motor controller, a torque command for a permanent magnet motor of an electric vehicle, wherein the permanent magnet motor is coupled to an inverter having transistors, and wherein the permanent magnet motor has a present speed; determining a present base speed of the permanent magnet motor; and in response to the torque command meeting a zero-torque criterion while the present speed meets a below-base-speed criterion, ceasing, by the motor controller, a toggling of the transistors so that the transistors are nonconductive.

### CROSS-REFERENCE TO RELATED APPLICATION

This application claims priority to U.S. Patent Application No. 63/262,911, filed on Oct. 22, 2021, and entitled “CEASING TRANSISTOR TOGGLING IN PERMANENT MAGNET MOTOR WHEN ZERO MOTOR TORQUE IS DEMANDED,” the disclosure of which is incorporated by reference herein in its entirety.

### TECHNICAL FIELD

This document relates to ceasing transistor toggling in a permanent magnet motor when zero motor torque is demanded.

### BACKGROUND

In recent years, electric vehicle (EV) technology has continued to develop, and an increasing number of people are choosing to have an EV as a personal vehicle. An EV has an onboard battery pack or other energy storage. The available range of driving distance for the EV is important to many people. As such, the EV should use energy efficiently.

### SUMMARY

In a first aspect, a method comprises: receiving, by a motor controller, a torque command for a permanent magnet motor of an electric vehicle, wherein the permanent magnet motor is coupled to an inverter having transistors, and wherein the permanent magnet motor has a present speed; determining a present base speed of the permanent magnet motor; and in response to the torque command meeting a zero-torque criterion while the present speed meets a below-base-speed criterion, ceasing, by the motor controller, a toggling of the transistors so that the transistors are nonconductive.

Implementations can include any or all of the following features. The motor controller receives multiple torque commands for the permanent magnet motor, the method further comprising performing torque command arbitration for the multiple torque commands, wherein the torque command results from the torque command arbitration. The present base speed is determined based on at least a direct-current voltage of the inverter and a back electromotive force constant of the permanent magnet motor. The zero-torque criterion comprises that the torque command is within a predefined margin of zero torque. The zero-torque criterion further comprises that the torque command is within the predefined margin of zero torque for at least a predefined time. The below-base-speed criterion comprises that the present speed is lower than the present base speed by at least a predefined margin. The method further comprises: determining, after ceasing the toggling of the transistors, that the torque command does not meet the zero-torque criterion; and in response to the determination, initiating toggling of the transistors. The zero-torque criterion comprises that the torque command is within a predefined margin of zero torque. The method further comprises: determining, after ceasing the toggling of the transistors, that the present speed does not meet the below-base-speed criterion; and in response to the determination, initiating toggling of the transistors. The below-base-speed criterion comprises that the present speed is lower than the present base speed by at least a predefined margin. The transistors are metal-oxide semiconductor field-effect transistors.

In a second aspect, a permanent magnet motor comprises: a motor controller to receive a torque command and determine a present base speed of the permanent magnet motor; an inverter having transistors; and a sensor indicating a present speed of the permanent magnet motor; wherein in response to the torque command meeting a zero-torque criterion while the present speed meets a below-base-speed criterion, the motor controller ceases a toggling of the transistors so that the transistors are nonconductive.

Implementations can include any or all of the following features. The motor controller receives multiple torque commands and performs torque command arbitration using a torque command arbitration component, and wherein the torque command results from the torque command arbitration. The zero-torque criterion comprises that the torque command is within a predefined margin of zero torque. The zero-torque criterion further comprises that the torque command is within the predefined margin of zero torque for at least a predefined time. The below-base-speed criterion comprises that the present speed is lower than the present base speed by at least a predefined margin. The transistors are metal-oxide semiconductor field-effect transistors.

### BRIEF DESCRIPTION OF DRAWINGS

FIG. 1 shows an example of a vehicle having a permanent magnet motor.

FIG. 2 shows an example of a torque command arbitration that can be performed by the motor controller of the vehicle in FIG. 1.

FIG. 3 shows an example of evaluating a below-base-speed criterion that can be performed by the motor controller of the vehicle in FIG. 1.

FIG. 4 shows an example of a motor control process that can be performed by the motor controller of the vehicle in FIG. 1.

Like reference symbols in the various drawings indicate like elements.

### DETAILED DESCRIPTION

This document describes examples of systems and techniques that cease transistor toggling in a permanent magnet motor when zero motor torque is demanded.

Examples described herein refer to a vehicle. A vehicle is a machine that transports passengers or cargo, or both. A vehicle can have one or more motors using at least one type of fuel or other energy source (e.g., electricity). Examples of vehicles include, but are not limited to, cars, trucks, and buses. The number of wheels can differ between types of vehicles, and one or more (e.g., all) of the wheels can be used for propulsion of the vehicle. The vehicle can include a passenger compartment accommodating one or more persons. An EV can be powered exclusively by electricity, or can use one or more other energy sources in addition to electricity, to name just a few examples. As used herein, an EV includes an onboard energy storage, sometimes referred to as a battery pack, to power one or more electric motors. Two or more EVs can have different types of energy storages and/or different sizes thereof.

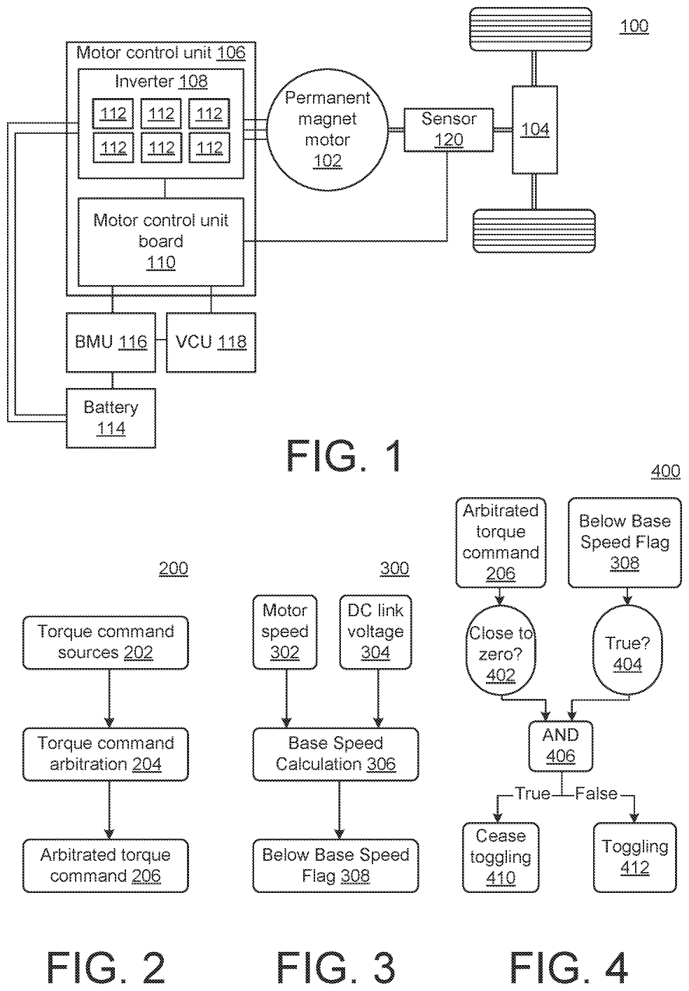

FIG. 1 shows an example of a vehicle 100 having a permanent magnet motor 102. The permanent magnet motor 102 and/or other components of the vehicle 100 can be used with one or more other examples described elsewhere herein. Only portions of the vehicle 100 are shown, for simplicity. The permanent magnet motor 102 has one or more magnets positioned within or on a surface of a rotor. The permanent magnet motor 102 can apply current to a stator surrounding the rotor to generate torque for one or more drive wheels. In some implementations, gears 104 can be provided between the permanent magnet motor 102 and the drive wheel(s). For example, the gears 104 can include a differential and/or can provide gear reduction.

The vehicle 100 can use a motor controller to operate the permanent magnet motor 102 as well as other components. Here, the vehicle 100 includes a motor control unit (MCU) 106 that includes an inverter 108 and an MCU board 110. The MCU board 110 controls the inverter 108. The MCU board 110 can include one or more processing components. In some implementations, the MCU board 110 includes one or more processors. For example, the MCU board 110 can also include one or more field-programmable gate arrays. The MCU 106 can also include one or more other components for controlling the permanent magnet motor 102. For example, gate drivers, shunt monitors, and cooling features can be included.

The inverter 108 can include one or more power stages to convert direct current (DC) to alternating current (AC) to drive the permanent magnet motor 102, and to convert AC to DC when recovering energy from the permanent magnet motor 102. The inverter 108 can use transistors 112 that are toggled on and off repeatedly to generate AC for, or recover energy from, the permanent magnet motor 102. In some implementations, six of the transistors 112 can be coupled in respective pairs to produce three-phase AC. The transistors 112 can be metal-oxide semiconductor field-effect transistors (MOSFETs). For example, silicon carbide MOSFETs can be used.

The vehicle 100 includes a battery 114. The battery 114 can include one or more modules of electrochemical cells. For example, lithium-ion cells can be used. The battery 114 can be controlled by a battery management unit (BMU) 116. For example, the BMU 116 can manage the state of charge of the battery 114, and open and close the contactors between the battery 114 and the inverter 108. The battery 114 which is the energy source for vehicle propulsion can be referred to as a high-voltage battery to distinguish it from a low-voltage (e.g., 12 V) battery that can power one or more components (e.g., the MCU board 110).

The MCU 106 can determine a base speed for the permanent magnet motor 102. When the permanent magnet motor 102 is spinning, the permanent magnets in the rotor generate a voltage called a back electromotive force (back emf). The inverter 108 can include freewheeling diodes. The back emf can eventually generate a DC voltage at the DC terminals of the battery 114. If this DC voltage increases and exceeds the voltage from the battery 114, this can create a potential flow direction of energy from the permanent magnet motor 102 to the battery 114. Such a condition can be felt in form of a braking torque generated by the permanent magnet motor 102 (sometimes referred to as uncommanded torque). The boundary where the back emf exceeds the battery voltage is speed-dependent. The base speed can be calculated based on a back emf constant and a DC voltage (e.g., a DC link voltage) of the inverter 108. That is, when the vehicle 100 travels slower than the base speed, the transistors 112 can be turned off without generating uncommanded torque.

The vehicle 100 includes a vehicle control unit (VCU) 118. The VCU 118 can control the operational state of the vehicle 100. In some implementations, the VCU 118 can be coupled to both the BMU 116 and the MCU board 110. For example, the VCU 118 can coordinate torque requests regarding the permanent magnet motor 102.

The vehicle 100 includes a sensor 120 that can indicate a rotational position of the rotor in the permanent magnet motor 102. In some implementations, the sensor 120 can be mounted to the shaft of the rotor and can give angle measurements. For example, the sensor 120 can include analog circuitry (e.g., a resolver) or digital circuitry (e.g., an encoder).

The transistors 112 can be subject to energy loss during operation. Toggling creates voltage transients and current transients which can give rise to switching losses. During operation, the transistors 112 can be toggled on and off at a relatively high frequency (e.g., in the range of about 5-20 kHz, to name just some examples). The switching loss is energy that is lost due to heat generation. For example, such energy lost can be estimated by way of calculating the integral of a product of voltage and current.

The vehicle 100 can execute a motor control strategy to improve efficiency. In some implementations, the toggling of the transistors 112 can be ceased so that the transistors 112 are nonconductive in one or more situations where it is determined that this does not adversely affect the operation of the vehicle 100. For example, when very little torque is requested at a time where the vehicle speed is lower than the threshold for uncommanded torque, the toggling of the transistors 112 can be ceased to render them nonconductive. As used herein, a transistor being nonconductive corresponds to a state where there is no active path between the positive terminal and the negative terminal of the battery 114. As mentioned above, the freewheeling diodes can provide a reverse path that is conductive also while the transistor is nonconductive.

FIG. 2 shows an example 200 of a torque command arbitration that can be performed by the motor controller of the vehicle in FIG. 1. The example 200 can be used with one or more other examples described elsewhere herein. Some components of FIG. 1 are mentioned as examples.

When the vehicle is driving, the VCU 118 can send a torque command to the MCU board 110, which may receive multiple torque commands from the vehicle 100. Here, torque command sources 202 are schematically illustrated. The MCU board 110, in turn, can pass the received torque commands to torque command arbitration 204. An arbitrated torque command 206 results from the arbitration. The MCU board 110 can then work with the inverter 108 to produce the torque corresponding to the arbitrated torque command 206. In implementations that do not have the torque command arbitration 204, the torque command that the MCU board 110 receives is applied without arbitration.

FIG. 3 shows an example 300 of evaluating a below-base-speed criterion that can be performed by the motor controller of the vehicle in FIG. 1. The example 300 can be used with one or more other examples described elsewhere herein. When the arbitrated torque command 206 in FIG. 2 (or a non-arbitrated torque command) is essentially zero, and the permanent magnet motor 102 is running below its base speed, the transistors 112 may not need to be toggled in order to maintain the torque output by the permanent magnet motor 102 at the zero level.

Here, a motor speed 302 represents the present speed of the permanent magnet motor 102. For example, the motor speed 302 is determined using the sensor 120. A DC link voltage 304 can be used in calculating the base speed of the permanent magnet motor 102. A base speed calculation 306 represents performance of a comparison involving the present speed and the base speed of the permanent magnet motor 102. This can be referred to as a below-base-speed criterion for the present speed. In some implementations, meeting the below-base-speed criterion comprises the present speed being lower than the present base speed. In other implementations, meeting the below-base-speed criterion comprises the present speed being lower than the present base speed by at least a predefined margin. For example, evaluation of the below-base-speed criterion involves comparing the motor speed 302 with the base speed, calculated using the DC link voltage 304, less a margin defined in percent. If the below-base-speed criterion is met, a below base speed flag 308 can be set.

FIG. 4 shows an example 400 of a motor control process that can be performed by the motor controller of the vehicle in FIG. 1. The example 400 can be used with one or more other examples described elsewhere herein.

For the arbitrated torque command 206 (or a non-arbitrated torque command), a determination 402 can be performed of whether it is close to zero. This can be referred to as a zero-torque criterion. In some implementations, meeting the zero-torque criterion can be defined as being within a predefined margin above and/or below zero torque. For example, such a zero-torque criterion can further require the torque command to be within the predefined margin of zero torque for at least a predefined amount of time. For the below base speed flag 308, a determination 404 can evaluate whether it is set (i.e., true).

The determinations 402 and 404 can be evaluated by a logical AND function 406. The logical AND function 406 generates the output True when both the determinations 402 and 404 are true. The logical AND function 406 generates the output False when either or both of the determinations 402 and 404 are false. That is, when the below base speed flag 308 is set, and the arbitrated torque command 206 (or a non-arbitrated torque command) is essentially zero, the motor controller can initiate a cease toggling state 410. For example, the cease toggling state 410 interrupts the ongoing toggling of the transistors 112 so that they are nonconductive. On the other hand, when the output of the logical AND function 406 is false, toggling 412 is performed.

The MCU board 110 can maintain the cease toggling state 410 for as long as the logical AND function 406 generates a true output; then, the MCU board 110 can resume toggling in response to a change in the output. For example, if it is determined, during the cease toggling state 410, that the arbitrated torque command 206 (or a non-arbitrated torque command) is no longer essentially zero, then in response to such determination the MCU board 110 can initiate the toggling 412. As another example, if it is determined, during the cease toggling state 410, that the below base speed flag 308 is no longer set, then in response to such determination the MCU board 110 can initiate the toggling 412.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A method comprising:
receiving, by a motor controller, a torque command for a permanent magnet motor of an electric vehicle, wherein the permanent magnet motor is coupled to an inverter having transistors, and wherein the permanent magnet motor has a present speed;
determining a present base speed of the permanent magnet motor; and
in response to the torque command meeting a zero-torque criterion while the present speed meets a below-base-speed criterion, ceasing, by the motor controller, a toggling of the transistors so that the transistors are nonconductive.

2. The method of claim 1, wherein the motor controller receives multiple torque commands for the permanent magnet motor, the method further comprising performing torque command arbitration for the multiple torque commands, wherein the torque command results from the torque command arbitration.

3. The method of claim 1, wherein the present base speed is determined based on at least a direct-current voltage of the inverter and a back electromotive force constant of the permanent magnet motor.

4. The method of claim 1, wherein the zero-torque criterion comprises that the torque command is within a predefined margin of zero torque.

5. The method of claim 4, wherein the zero-torque criterion further comprises that the torque command is within the predefined margin of zero torque for at least a predefined time.

6. The method of claim 1, wherein the below-base-speed criterion comprises that the present speed is lower than the present base speed by at least a predefined margin.

7. The method of claim 1, further comprising:
determining, after ceasing the toggling of the transistors, that the torque command does not meet the zero-torque criterion; and
in response to the determination, initiating toggling of the transistors.

8. The method of claim 7, wherein the zero-torque criterion comprises that the torque command is within a predefined margin of zero torque.

9. The method of claim 1, further comprising:
determining, after ceasing the toggling of the transistors, that the present speed does not meet the below-base-speed criterion; and
in response to the determination, initiating toggling of the transistors.

10. The method of claim 9, wherein the below-base-speed criterion comprises that the present speed is lower than the present base speed by at least a predefined margin.

11. The method of claim 1, wherein the transistors are metal-oxide semiconductor field-effect transistors.

12. A permanent magnet motor comprising:
a motor controller to receive a torque command and determine a present base speed of the permanent magnet motor;
an inverter having transistors; and
a sensor indicating a present speed of the permanent magnet motor;
wherein in response to the torque command meeting a zero-torque criterion while the present speed meets a below-base-speed criterion, the motor controller ceases a toggling of the transistors so that the transistors are nonconductive.

13. The permanent magnet motor of claim 12, wherein the motor controller receives multiple torque commands and performs torque command arbitration using a torque command arbitration component, and wherein the torque command results from the torque command arbitration.

14. The permanent magnet motor of claim 12, wherein the zero-torque criterion comprises that the torque command is within a predefined margin of zero torque.

15. The permanent magnet motor of claim 14, wherein the zero-torque criterion further comprises that the torque command is within the predefined margin of zero torque for at least a predefined time.

16. The permanent magnet motor of claim 12, wherein the below-base-speed criterion comprises that the present speed is lower than the present base speed by at least a predefined margin.

17. The permanent magnet motor of claim 12, wherein the transistors are metal-oxide semiconductor field-effect transistors.
